(19) United States
(12) Patent Application Publication
(10) Pub. No.: US 2018/0208770 A1
(43) Pub. Date: Jul. 26, 2018

(54) DENSIFYING AGENT

(71) Applicant: CPC CORPORATION, TAIWAN, Taipei City (TW)

(72) Inventors: Chia-Lin CHANG, Chiayi City (TW); Guo-Hsu LU, Chiayi City (TW)

(21) Appl. No.: 15/817,910

(22) Filed: Nov. 20, 2017

(30) Foreign Application Priority Data
Jan. 20, 2017 (TW) 106102047

(51) Int. Cl. C08L 95/00; C08K 3/04

(52) U.S. Cl. CPC C08L 95/00; C08K 3/04

(57) ABSTRACT

The present invention provides a densifying agent adopted a total weight of a refined pitch which is 100 as a basis, the composition of the refined pitch includes 19-30 toluene insolubles (TI) by weight, 0.1˜0.3 quinoline insolubles (QI) by weight, 0˜0.001 ash by weight and 18˜30 quinoline solubles (QS) by weight, in which the temperature of the softening point of the refined pitch is in the range of about 120° C. to 140° C. Accordingly, the amount of the toluene insolubles (TI) and the small amount of the quinoline insolubles (QI) can be mixed with the carbon-based material to increase the density of the carbon-based material, and the content of the quinoline solubles (QS) is used for adjusting the binding effect of the densifying agent with the binder.

### CROSS-REFERENCE TO RELATED APPLICATIONS

This application claims priority to Taiwan Patent Application No. 106102047, filed Jan. 20, 2017, the content of which are hereby incorporated by reference in their entirety.

### FIELD OF THE INVENTION

The present invention relates to a densifying agent, and more particularly relates to a densifying agent whose main composition is a refined pitch for increasing a density of carbon-based material.

### BACKGROUND OF THE INVENTION

High performance carbon-based materials have been paid attention by people because of their good electric conductivities, thermal conductivities, high-temperature mechanics performance and chemical stabilities. Thus, high performance carbon-based materials have been used in various fields or applications, such as electrical engineering, metallurgy, mechanics, chemical engineering, nuclear energy, military and aerospace industries, household appliance, physical education and medical appliance.

High performance carbon-based materials, such as carbon/carbon composites material or industrial graphite material, can be acquired by adding filler with binder into graphite matrix, processing of extrusion or modulation compression for formation, and thermal treatment of high-temperature carbonation. However, during the thermal treatment, different shrinkages of graphite matrix and filler possibly cause cracks and pores. The cracks and pores will reduce density and mechanical strength of carbon material, as well as thermal conductivity. Thus, an extra step of densification for carbon-based material after extrusion or module compression by impregnating into densifying agent are performed many times to fill up cracks and pores and enhance the density of carbon-based material, so as to make high performance carbon-based material meet requirements. The treatment temperature for the densification is equal or larger than 600° C., and the treatment pressure is equal or larger than 12000 psi.

A main composition of a binder or a densifying agent is the pitch which may come from petroleum, coke or the mixture. The pitch is thermal plastic and generally a mixture of hundreds of aromatic hydrocarbon with polycyclic compounds of 3˜8 aromatic rings. At room temperature, pitch is a black solid of glass phase. Dependent on different solubility degrees for different solvents, pitch may be separated out different composition of different molecular weight. The softening point (SP), viscosity, high-temperature fluidity (pore penetration capability) and coking value (CV) of pitch are subject to contents or ratio of different compositions. These features of pitch directly reflect on applications of binder field or densifying agent field.

FIG. 1 is a schematic of illustrating composition of typical pitch. The pitch (C1) may be separated by toluene (solvent) to distinguish toluene insolubles (TI) (C11) from toluene solubles (TS) (also called γ-resin) (C12). The molecular weight of the toluene solubles (TI) (C12) is in the range of about 200 to 1000 Dalton. The toluene insolubles (C11) is further separated by quinoline solvent to distinguish quinoline insolubles (QI) (also called α-resin) (C111) and quinoline solubles (QS) (also called β-resin) (C112). The molecular weight of the quinoline insolubles (QI) (C111) is more than 1800 Dalton. The molecular weight of the quinoline solubles (QS) (C112) is in the range of about 1000 to 1800 Dalton. The amount of β-resin of the pitch (i.e., quinoline solubles, QS) represents the ability of the pitch itself to bind. Accordingly, the content of the β-resin is as higher as possible for the pitch with high quality.

A ratio of carbon and hydrogen (C/H) for the toluene solubles (TS) (C12) is in the range of about 0.56 to 1.25 to reduce a viscosity of pitch and to improve the plasticity. However, too much toluene solubles (TS) will influence a coking value of pitch, and such the pitch used as a binder or a densifying agent, the toulene solubles (TS) will escape in gas form during the densification such that the pitch fails to efficiently fill up cracks or pores within a carbon-based material. The toluene insolubles (C11) as a component of a binder has a value of 1.53 for ratio of C/H, and the quinoline insolubles (QI) (C111) of C/H ratio is more than 1.67. The quinoline insolubles (QI) (C111) includes primary quinoline insolubles (QI) and secondary quinoline insolubles (QI). The primary quinoline insolubles (QI) is derived from the raw oil includes inorganic impurities and large molecular aromatics. The secondary quinoline insolubles (QI) are derived from polycondensation of other substances exclusive of primary quinoline insolubles (QI) during a coking process of pitch. The quinoline insolubles (QI) (C111) are no impregnation and binding capabilities. Though the secondary quinoline insolubles (QI) of moderate amount may improve a coking value of a binder, however, the one of over amount often reduces viscosity of pitch and blocks pores within carbon-based material to reduce impregnation effect of the binder. The ratio of C/H of the quinoline solubles (QS) (C112) contained in the toluene insolubles (T1) (C11) is in the range of about 1.25 to 2.0. The quinoline solubles (QS) (C112) is a main composition to perform binding function for a binder. The more quinoline solubles (QS) (C112) is, the better the electrical resistance, thermal conductivity and mechanical strength of the carbon-based material.

The pitch that is performed by refined process is an existing technology. For example, the remained quinoline insolubles (QI) in the pitch is removed to obtain the refined pitch with low content of the quinoline insolubles (QI), the softening point of the pitch is reduced after heating and stirring treatment or the molecular weight ratio of the pitch itself is adjusted to achieve the high quality carbon material and meet the industrial standard. During the high-pressure heat treatment, by the means of introduce the gas to control the polycondensation degree of the pitch to achieve the purpose for the refining of the pitch.

In general, during a refined process, it is difficult to control the polycondensation degree for pitch that is used as a binder or a densifying agent, so that large-area molecules due to excess polycondensation are formed to result in sharply increasing quinoline insolubles (QI) and sharply raising softening point. Too high content of quinoline insolubles (QI) reduces high-temperature fluidity of pitch, blocks ventilating pores of carbon-based material, and influencing impregnation effect of densifying agent. If the softening point of the pitch is too higher, when the pitch is used as a densifying agent, in addition to increase the operation cost and the high softening point are possibly polycondensated to form solid-state free carbon to further generate gas by pyrolysis at high temperature. Such gas may stay within interior of pitch to result in defects within interior of pitch. However, provided that the polycondensation degree for medium and high molecular substances is reduced because of reduction of softening point, ratio of lower molecular substances in pitch will be raised. Too much low-molecular substances may volatile in large degree during the thermal treatment for high-temperature carbonation, so as to reduce the coking value of pitch.

### SUMMARY OF THE INVENTION

With respect to the issues aforementioned, a densifying agent is applied for raising the density of the carbon-based material which is provided. The densifying agent adopted a total weight of a refined pitch which is 100 as a basis. The composition of the densifying agent includes 19˜30 toluene insolubles (TI) by weight, 0.1˜0.3 quinoline insolubles (QI) by weight, 0˜0.001 ash by weight and 18˜30 quinoline solubles (QS) by weight; wherein the temperature of a softening point of the refined pitch is in the range of 120° C. to140° C.

In one example, a coking value of the refined pitch is in the range of about 56%˜60%.

In one example, a density of the refined pitch is in the range of about 1.2 g/cm³ to 1.3 g/cm³.

In one example, a yield of high-temperature carbon of the refined pitch is in the range of about 94%˜96%.

According to aforementioned, the refined pitch of the present invention includes higher content of the toluene insolubles (TI) that can perform a good binding capability. Moreover, due to the lower contents of the quinoline insolubles (QI) and ash, the refined pitch of the present invention has a good impregnation capability.

According to aforementioned, the refined pitch with lower softening point may prevent the refined pitch from becoming solid-state free carbon due to re-polycondensation and then forming gas by pyrolysis at high temperature and the operation cost is to be reduced. Furthermore, the better coking value is substantially beneficial to the densifying rate and the yield of high-temperature carbon during the manufacturing of the high-density carbon-based material, which may reduce the times of the hot isostatic pressing on the primary carbon-based material so as to efficiently simply the processing steps and reduce energy loss.

According to aforementioned, the refined pitch of the present invention may be as the densifying agent or the densifying agent with the binder, and adjusting or preparing the different composition according to the binding or densifying requirement is unnecessary for the refined pitch. Thus, the present invention is of industrial value.

### BRIEF DESCRIPTION OF THE DRAWINGS

FIG. 1 is a schematic of illustrating components of typical pitch.

FIG. 2 is a schematic of illustrating refined pitch as a densifying agent with a binder for preparation of primary carbon-based material in accordance with the present invention.

FIG. 3 is a schematic of illustrating refined pitch as a densifying agent for preparation of high-density carbon-based material in accordance with the present invention.

FIG. 4 is a flowchart of illustrating a verification and ablation test for an engine in accordance with the present invention.

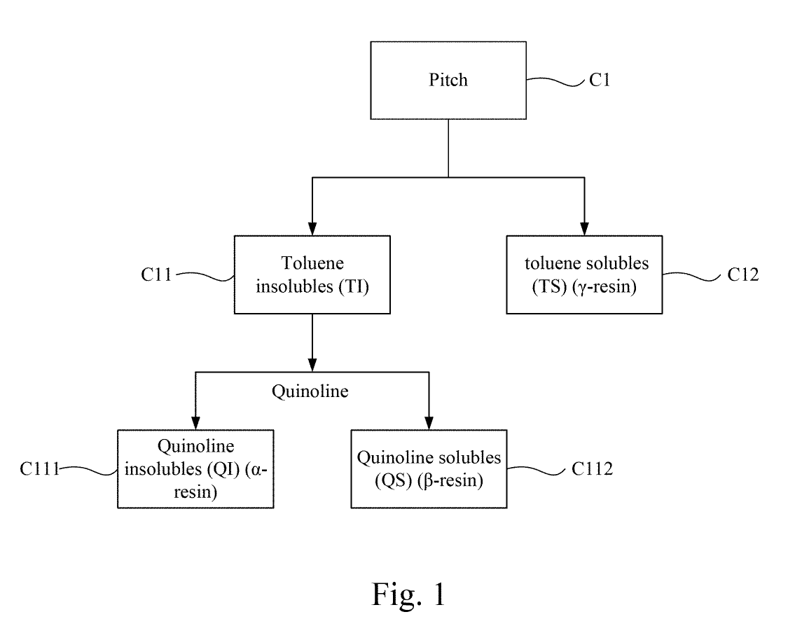

### DETAILED DESCRIPTION OF THE PREFERRED EMBODIMENT

Advantages and features of the present invention may be understood with components and examples of the present invention in companying drawings and embodiments. However, sizes and shapes shown on drawings for the present invention and embodiments in this specification do not limit the features of the present invention. One of skilled in the art will acknowledge claimed range of the present invention with the embodiment in clear and concise disclosure.

The present invention provides a densifying agent which has the mainly component with refined pitch is used for enhancement on a density of graphite material or carbon-based material. The heavy oil (Chinese Petroleum Corporation Tawian (CPC Corporation Taiwan), CPC004) of the present invention is subjected to a thermal reaction treatment by the way of a pressurized and ventilation to keep the light-molecular substances in the heavy oil within the thermal reaction system without overflowing. In this manner, the viscosity of the substances in the thermal reaction can be reduced and heavy substances can be easily polymerized. In addition, the oxygen gas is pumped into the thermal reaction by using an oxygen-pumping method to be a cross-linking agent in the thermal reaction such that the time of the thermal reaction can be reduced and a reaction temperature can be lowered. The polycondensation degree may be efficiently controlled by reducing the reaction temperature. The densifying agent of the present invention may be acquired by above pressurization process and the oxygen-pumping method. In this embodiment, the reaction conditions includes the pressure range is in the range of about 0˜10 atmospheric pressure, the thermal reaction time is in the range of about 0.5˜2 hours, the gas introducing duration is in the range of about 0.5˜2 hours and the reaction temperature is in the range of about 380° C.˜430□. By using the reaction condition of above pressurization process and the oxygen-pumping method, the content of the quinoline insolubles (QI) within the refined pitch can be increased. In addition, the content of quinoline insolubles (QI) within the refined pitch is higher than that of the content of the quinoline insolubles (QI) within the pitch which is manufactured by current technologies. Therefore, the densifying agent of the present invention can be obtained. The densifying agent adopted a total weight of a refined pitch which is 100 as a basis, and the densifying agent of the present invention includes toluene insolubles (TI), quinoline insolubles (QI), quinoline solubles (QS) and a small amount of ash, and the physical and chemical properties of the refined pitch is summarized in the following table 1:

TABLE 1

| Physical and chemical | refined pitch of the | Measurement |
|---|---|---|
| properties | present invention | standard |
| softening point (° C.) | 120~140 | ASTM 3104 |
| toluene insolubles | >15 | JIS K2425 |
| (wt %) | | |
| quinoline insolubles | 0.1~0.3 | ASTM D2318 |
| (wt %) | | |
| Ash (wt %) | <0.001 | ASTM D2415 |
| fixed carbon/coking | 56%~60% | ASTM D189 |
| value (%) | | |
| Density (g/cm³) | 1.2~1.3 | ASTM D4892 |
| Viscosity (CPS) | 136 | 250° C.(1 rpm) |
| | 41 | 300° C.(1 rpm) |
| Element analysis (C/H | 1.4~1.6 | |
| wt %) | | |

According to the measuring results in table 1, due to the reduction of the thermal reaction time and the low of the reaction temperature, such that the yield of the quinoline insolubles (QI) is generated by the polycondensation of the refined pitch is to be reduced. The composition of the refined pitch of the present invention includes the quinoline insolubles (QI) that is in the range of about 0.1˜0.3 by weight, and the softening point of the refined pitch kept in the range of about 100° C.˜140° C. and the preferred softening point is in the range of about 120° C.˜140° C. The low content of the quinoline insolubles also represents the refined pitch is high purity and without impurities therein, and there may be no penetration resistance during a densification procedure. Furthermore, the coking value of the refined pitch is in the range of about 50%˜60% and the prefered coking value is in the range of about 56%˜60% that represents the more substance with heavy-molecular weight within the refined pitch in the present invention. In another embodiment of the present invention, the coking value of the refined pitch may be more than 53% and the preferred coking value of the refined pitch is more than 56% by keeping the softening point of the refined pitch is in the range of about 100° C.˜140° C. and the preferred softening point of the refined pitch is in the range of about 120° C.˜140° C. and the composition of the toluene insolubles (TI) within the refined pitch is more than 30 by weight.

It is to be illustrated that the coking value is calculated as following. The refined pitch sample is weighed, and in a weight of m. The crucible is dried and weighed, and in a weight of m1. The refined pitch sample is placed in a crucible and placed in a high temperature furnace for heating. Then, the crucible and the residue in the crucible together are weighed, and in the weight of m2 The coking value of the refined pitch is calculated by the coking value formula, K=((m2−m1)/m)*100%, Herein, the K value of the coking value formula is coal tar pitch value, in units of (%). In addition, quinoline solubles (QS) can be called as β-resin, the content of the quinoline solubles (QS) (or β-resin) obtained by subtracting the composition of the toluene insolubles (TI) by weight from the composition of the quinoline insolubles (QI) by weight. Accordingly, the content of the β-resin is as higher as possible for the refined pitch with high quality. The preparation of primary carbon-based material with the refined pitch as a binder is illustrated.

### EXAMPLE 1

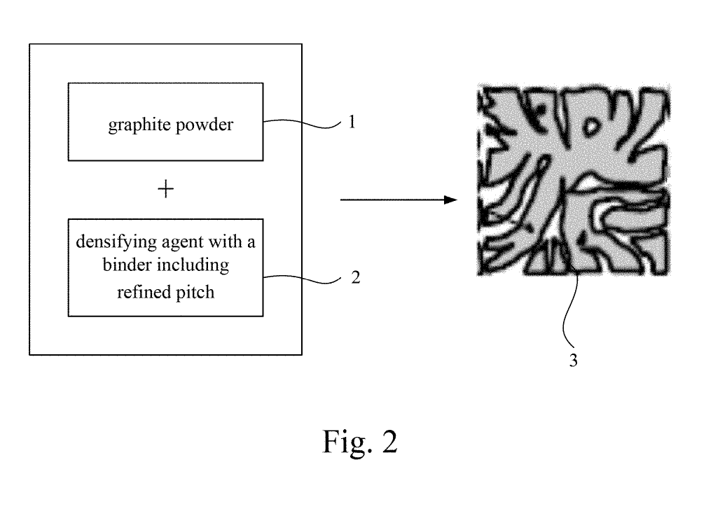

FIG. 2 is a schematic of illustrating refined pitch as a densifying agent with a binder for the preparation of the primary carbon-based material according to the present invention. The graphite powder 1 is mixed with a densifying agent with a binder 2 including the refined pitch and treated by extrusion formation to acquire a primary carbon-based material 3. Due to both the more content of quinoline solubles (QS) which is a main ingredient for performing binding in the densifying agent and the refined pitch of the present invention is used to perform binding for the preparation of the primary carbon-based material.

The preparation of high-density carbon-based material with the refined pitch as a densifying agent is illustrated.

### EXAMPLE 2

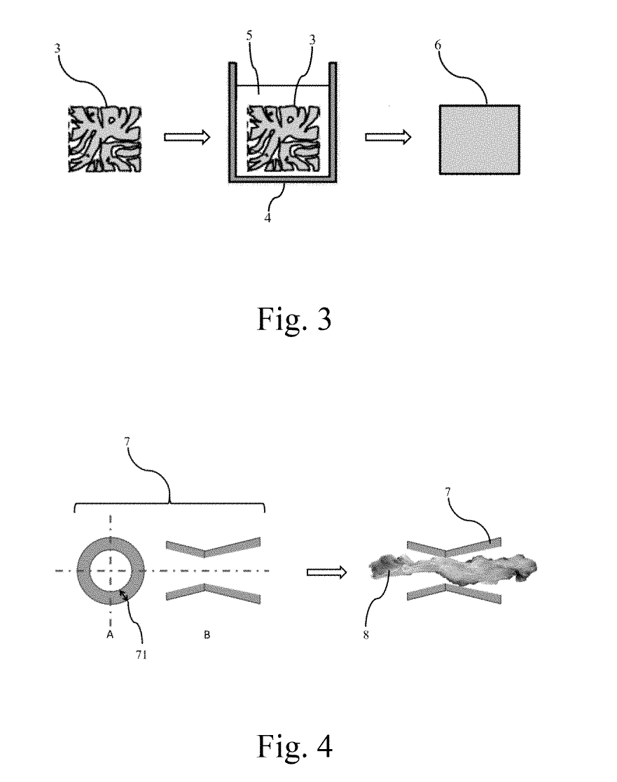

FIG. 3 is a schematic of illustrating refined pitch as a densifying agent for the preparation of the high-density carbon-based material according to the present invention. The primary carbon-based material 3 is put into a container 4 and impregnated by adding the densifying agent 5 with the refined pitch. Next, the primary carbon-based material 3 is treated by hot isostatic pressing (HIP) at a temperature over 600° C. and a pressure of 12,000 PSI (pounds per square inch), then by carbonation reaction at temperature over 900° C. for two hours, and finally by graphitization at temperature over 2300° C. for one hour to acquire the high-density carbon-based material 6. For increasing the density of the high-density carbon-based material 6, the high-density carbon-based material 6 may be repeatedly treated by the steps of the hot isostatic pressing for two, three or more times. It is noted that the primary carbon-based material 3 may be prepared by the method shown in FIG. 2 or using a mass-production graphite bulk material having density of about 1.7 g/cm³˜1.8 g/cm³.

To measure the effects of the densifying agent of the present invention, index product A240 of the United States, samples EX1, EX2 and EX3 including the densifying agent with the refined pitch of the present invention, respectively, are measured for their respective physical and chemical properties and densification performance. A laboratory analysis on the physical and chemical properties includes: softening point (°C.), toluene insolubles (TI), quinoline insolubles (QI), ash and fixed carbon/coking value (%), and has a result shown in table 2. The densification performance is to measure the characteristics of the high-density carbon-based material including: original density of the primary carbon-based material (g/cm³), density of the primary carbon-based material by one-time densification (g/cm³), ratio of one-time densification (%), thermal expansion coefficient (*10⁻⁶/K) and yield of high-temperature carbon (%). The measurement result is shown in table 3:

TABLE 2

| | index | | | | |
|---|---|---|---|---|---|
| | product | | | | |
| | A240 of | | | | |
| | the | | | | |
| Physical and | United | densifying agent | | | |
| chemical | States | including refined pitch | | | Measurement |
| properties | A240 | EX1 | EX2 | EX3 | standard |
| softening point | 130.1 | 100 | 120.5 | 136.45 | ASTM 3104 |
| (° C.) | | | | | |
| toluene | 5.17 | 16.17 | 23.43 | 29.5 | JIS K2425 |
| insolubles | | | | | |
| (wt %) | | | | | |
| quinoline | 0.17 | 0 | 0 | 0.295 | ASTM D2318 |
| insolubles | | | | | |
| (wt %) | | | | | |
| ash (wt %) | 0.16 | 0.005 | 0.003 | ~0 | ASTM D2415 |
| fixed carbon/ | 50.0 | 50.4 | 55.0 | 55.4 | ASTM D189 |
| coking value) | | | | | |
| (%) | | | | | |

TABLE 3

| | index product | | | | | |
|---|---|---|---|---|---|---|
| Measurement on | A240 of the | densifying agent including | | | | |
| densification | United States | refined pitch | | | | |
| performance | A240 | EX1 | EX2 | EX3 | | Note |
| original density | 1.821 | 1.792 | 1.763 | 1.775 | 1.83 | Measurement |
| of the primary | | | | | | standard |
| carbon-based | | | | | | ASTM C559 |
| material (g/cm³) | | | | | | |
| density of the | 1.912 | 1.905 | 1.913 | 1.904 | 1.917 | After |
| primary | | | | | | carbonation |
| carbon-based | | | | | | and |
| material by | | | | | | graphitization |
| one-time | | | | | | |
| densification | | | | | | |
| (g/cm³) | | | | | | |
| ratio of one-time | 5.00 | 6.31 | 5.81 | 7.29 | 4.76 | |
| densification (%) | | | | | | |
| yield of | 91.42 | 93.63 | 93.64 | 93.35 | 93.36 | Three-times |
| high-temperature | | | | | | |
| carbon (%) | | | | | | |
| thermal | 5.1 | 4.8 | 4.7 | 4.15 | 4.73 | Measurement |
| expansion | | | | | | standard |
| coefficient | | | | | | ASTM E831 |
| (×10⁻⁶/K) | | | | | | |

From the results in table 2 and table 3, the composition of the quinoline insolubles (QI) within the refined pitch of the present invention is less than 0.3 by weight and the preferred composition of quinoline insolubles within the refined pitch is in the range of about 0.1˜0.3 by weight in another embodiment. The composition of ash within the refined pitch is also lower than that of the mass-production index product A240 of the United States, and even the refined pitch without ash therein which means that the densifying agent contains the less ash or without ash within the refined pitch in the densification process, the more impregnation ability of the refined pitch. Besides, the moderate softening point may prevents the refined pitch during a too-high temperature treatment from becoming solid-state free carbon due to polycondensation and then forming gas by pyrolysis at high temperature.

Besides, due to the refined pitch includes the more substance with heavy-molecular weight therein, the ratio of the fixed carbon and coking value is better than that of the mass-production index product A240 of the United States. The high ratio of the fixed carbon and coking value raises both the ratio of one-time densification to be near or more than 5% and the yield of high-temperature carbon is in the range of about 92%˜96%, and the preferred yield of high-temperature carbon is in the range of about 94%˜96% for the high-density carbon-based material. Consequently, the densifying agent of the present invention performs better than the mass-production index product A240 of the United States does (as shown in Table 3). Moreover, it is noted that the thermal expansion coefficient of the high-density carbon-based material of the present invention is less than 5%, which does not increase along with the increasing of density. Consequently, the high-density carbon-based material of the present invention may meet requirement of sequential procedures. It is noted to illustrate that the impregnation process of refined pitch is carried out in the environment of a high temperature and high pressure, so that the high-temperature carbon yield is very important. The definition of the high-temperature carbon yield of the present invention is the percentage of remained carbon after a period of high temperature reaction. Due to the high-temperature carbon yield is relative with the impregnation capabilities of the carbon material impregnated, so that the embodiment of the present invention has been demonstrated that the more carbon content that can be stayed after high-temperature impregnation is performed which is better.

Test of High-Temperature Ablation Rate

### EXAMPLE 3

FIG. 4 is a flowchart of illustrating a verification and ablation test for an engine according to the present invention. Please refer to FIG. 4, the high-density carbon-based material 6 in FIG. 3 is processed to form a graphite converging-diverging nozzle 7 (the nozzle including a throat coupling converging section and diverging section herein), in which “A” represents the front diagram of the graphite converging-diverging nozzle 7 and “B” represents the side-view diagram of the graphite converging-diverging nozzle 7. A throat 71 of the graphite converging-diverging nozzle 7 is shown on the front diagram “A”. Next, the graphite converging-diverging nozzle 7 is treated by an ablation test with an engine generating flame at temperature over 2,000° C. Shown in FIG. 4, in the case of the flame 8 from the engine passing through within the graphite converging-diverging nozzle 7 for 3˜4 seconds, an average pressure (kgf/cm²) and an average thrust force (kgf) within the graphite converging-diverging nozzle 7 can be measured. A diameter variation for the throat 71 can be measured after the ablation test is finished and ablation amount and single ablation rate of the throat 71 can be acquired. Another index product A240 of the United States, samples EX1, EX2 and EX3 with the graphite converging-diverging nozzle 7 made of the high-density carbon-based material 6 that includes the densifying agent with the refined pitch of the present invention, respectively, are treated by a high-temperature ablation rate test and measured. The measurement result is shown in table 4:

TABLE 4

| | | throat | | | | | | |
|---|---|---|---|---|---|---|---|---|
| | throat | diameter | | | Single | | average | Average |
| | diameter | after | Ablation | | ablation | Average | thrust | ablation |
| densifying | before | test | amount | Processing | rate | pressure | force | rate |
| agent | test (mm) | (mm) | (mm) | time(s) | (mm/s) | (kgf/cm²) | (kgf) | (mm/s) |
| A240 | 12.66 | 13.0 | 0.34 | 3.24 | 0.105 | 73.52 | 139.56 | 0.097 |
| | 13.0 | 13.65 | 0.65 | 3.3115 | 0.196 | 68.84 | 135.57 | |
| | 13.65 | 13.9 | 0.25 | 3.4855 | 0.072 | 60.53 | 124.9 | |
| | 13.9 | 13.95 | 0.05 | 3.6845 | 0.014 | 54.54 | 118.43 | |
| EX1 | 12.66 | 13 | 0.34 | 3.2385 | 0.105 | 74.21 | 141 | 0.085 |
| | 13 | 13.25 | 0.25 | 3.2685 | 0.076 | 71.43 | 138.76 | |
| | 13.25 | 13.65 | 0.4 | 3.4495 | 0.116 | 62.7 | 127 | |
| | 13.65 | 13.8 | 0.15 | 3.625 | 0.041 | 56.85 | 119.23 | |
| EX2 | 12.65 | 13.15 | 0.5 | 3.2795 | 0.152 | 72.78 | 139.97 | 0.096 |
| | 13.15 | 13.5 | 0.35 | 3.24 | 0.108 | 69 | 138.21 | |
| | 13.5 | 13.6 | 0.1 | 3.549 | 0.028 | 58.15 | 122.99 | |

From the result in table 4, the ablation rate of the graphite converging-diverging nozzle 7 made of the index product A240 of the United States is 0.097 mm/s The ablation rates of the graphite converging-diverging nozzles 7 respectively made of the densifying agent EX1 and EX2 of the present invention are 0.085 mm/s and 0.116 mm/s, respectively. Besides, the diameter variations of the graphite converging-diverging nozzles 7 respectively made of the densifying agent EX1 and EX2 of the present invention have little change and their ablation amounts are kept at a level. Compared with the one made of the index product A240 of the United States, the graphite converging-diverging nozzles 7 respectively made of the densifying agent EX1 and EX2 of the present invention have excellent performances on anti-ablation capability. Accordingly, the densifying agent including the refined pitch of the present invention is of good binding capability.

Accordingly, that the refined pitch of the present invention includes a higher content of the toluene insolubles and has a good binding capability. Moreover, due to the lower contents of the quinoline insolubles (QI) and ash (or without ash therein), the refined pitch of the present invention has a good impregnation capability. On the other hand, the lower softening point may prevent the refined pitch from becoming solid-state free carbon due to re-polycondensation and then forming gas by pyrolysis under a high temperature. Furthermore, the better coking value is substantially beneficial to the densifying rate and the yield of high-temperature carbon during the manufacturing of the high-density carbon-based material, which may reduce the times of the hot isostatic pressing on the primary carbon-based material so as to efficiently simply the processing steps and reduce energy loss. Accordingly, the refined pitch provided in the present invention may be as the densifying agent or the densifying agent with the binder, and it is not necessary for the refined pitch provided in the present invention to be adjusted with different compositions for binding or densifying requirement. Thus, the present invention is of industrial value.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A densifying agent adopted a total weight of a refined pitch which is 100 as a basis, a composition of the refined pitch comprising:
19˜30 toluene insolubles by weight;
0.1˜0.3 quinoline insolubles by weight;
0˜0.0001 ash by weight; and
18˜30 quinoline solubles by weight,
wherein the temperature of a softening point of the refined pitch is in the range of 120° C. to 140° C.

2. The densifying agent according to claim 1, wherein a coking value of the refined pitch is in the range of about 50%˜60%.

3. The densifying agent according to claim 1, wherein a coking value of the refined pitch is in the range of about 56%˜60%.

4. The densifying agent according to claim 1, wherein a density of the refined pitch is in the range of about 1.2 g/cm³ to 1.3 g/cm³.

5. The densifying agent according to claim 1, further comprising a binder.

6. The densifying agent according to claim 1, wherein a yield of high-temperature carbon of the refined pitch is in the range of about 92%˜96%.

7. The densifying agent according to claim 1, wherein a yield of high-temperature carbon of the refined pitch is in the range of about 94%˜96%.
